(19) United States
(12) Patent Application Publication
(10) Pub. No.: US 2017/0099210 A1
(43) Pub. Date: Apr. 6, 2017

(54) Systems and Methods for Energy-Aware IP/MPLS Routing

(71) Applicant: Cisco Technology, Inc., San Jose, CA (US)

(72) Inventors: Reza Fardid, Sunnyvale, CA (US); Alan Thornton Gous, Palo Alto, CA (US)

(21) Appl. No.: 14/874,709

(22) Filed: Oct. 5, 2015

(51) Int. Cl. H04L 12/751; H04L 12/26

(52) U.S. Cl. CPC H04L 45/02; H04L 43/08

(57) ABSTRACT

In one embodiment, a method of energy-aware routing includes modifying a reference topology of a network by removing at least a portion of a first node from the reference topology, wherein the first node is associated with a power efficiency criterion. The method also includes determining whether one or more performance criteria are satisfied based on assessing a projected response of the modified reference topology to reference traffic. The method further includes scheduling at least partial shut-down of the first node in response to determining that the one or more performance criteria are satisfied. In some implementations, the one or more performance criteria include at least one of a latency threshold, a bandwidth utilization threshold, a redundancy criterion, and a power consumption threshold. In some implementations, the first node is one of a router, a line card, an interface, or a bundle of one or more ports.

### TECHNICAL FIELD

The present disclosure generally relates to network routing, and in particular, to systems, methods, and devices enabling energy-aware routing.

### BACKGROUND

The amount of global Internet protocol (IP) traffic (e.g., the fixed Internet) is forecast to have a compound annual growth rate of 20% from 2013 to 2018. There are many drivers of this growth. However, two major drivers behind this growth are the proliferation of cloud computing and inter-cloud/data center traffic, and rising video traffic. Despite advances made in silicon technologies used in core routers deployed in Internet service provider (ISP), managed service provider (MSP), and over-the-top (OTT) content delivery networks, the power consumption of these core routers rises with their capacity to meet growing traffic demands. For example, the capacity and the power consumption of some core routers grew by factors of 2.5 and 1.65, respectively, every 18 months, on a per-rack basis, between 1985 and 2010.

Service providers have at least two incentives for reducing network power consumption: the reduction of operational costs while maintaining service levels; and environmental concerns (e.g., the reduction of CO₂ emissions). There are predictable changes in network usage over different times of the day/week. Devices and portions thereof of the network may be underutilized during lulls in network traffic, yet still consume great amounts of power. As such, power is wasted during these periods of underutilization.

Some routing and traffic engineering methods optimize power consumption in multiprotocol label switching (MPLS) networks by periodically adjusting label switched paths (LSPs). Such optimization in MPLS networks is based on resource reservation protocol-traffic engineering (RSVP-TE) signaling, which lacks both the scalability to keep up with growth demands and centralized control for path optimization purposes.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example data network environment in accordance with some implementations.

FIG. 2 is a block diagram of a data processing environment in accordance with some implementations.

FIG. 3 is a block diagram of an example data structure in accordance with some implementations.

FIGS. 4A-4B illustrate schematic diagrams of example network configurations in accordance with various implementations.

FIG. 5 is a flowchart representation of a method of energy-aware routing in accordance with some implementations.

FIG. 6 is a flowchart representation of another method of energy-aware routing in accordance with some implementations.

FIGS. 7A-7C show a flowchart representation of yet another method of energy-aware routing in accordance with some implementations.

FIG. 8 is a block diagram of an example of a device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION OF EXAMPLE EMBODIMENTS

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

### Overview

Various implementations disclosed herein include devices, systems, and methods for energy-aware routing. For example, in some implementations, a method includes modifying a reference topology of a network by removing at least a portion of a first node from the reference topology, where the first node is associated with a power efficiency criterion. The method also includes determining whether one or more performance criteria are satisfied based on assessing a projected response of the modified reference topology to reference traffic. The method further includes scheduling at least partial shut-down of the first node in response to determining that the one or more performance criteria are satisfied.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### Example Embodiments

According to some implementations, the present disclosure provides a system and method for energy-aware routing that leverages centralized control of a network (e.g., segment routing or, more generally, source routing) to: generate an up-to-date model of the network; run simulations on the model using historic traffic information whereby devices in the network or portions thereof (e.g., line cards, interfaces, or bundles of ports) are deactivated and traffic is rerouted to minimize network-wide power consumption and improve bandwidth utilization; and deploy the reduced topology as long as performance criteria (e.g., latency, bandwidth utilization, redundancy, and the like) are satisfied under the simulation. This predictive modeling approach enables the simulation of power-savings scenarios over a specified time period prior to network deployment.

According to some implementations, the system and method for energy-aware routing uses segment routing, which is applicable to a pure Internet protocol version 6 (IPv6) data plane and does not require resource reservation protocol-traffic engineering (RSVP-TE) signaling, while nonetheless applicable to multiprotocol label switching (MPLS). Segment routing enables centralized software defined network (SDN) traffic engineering and power optimization. According to some implementations the system and method for energy-aware routing is also applicable to a pure Internet protocol version 4 (IPv4) data plane, without segment routing.

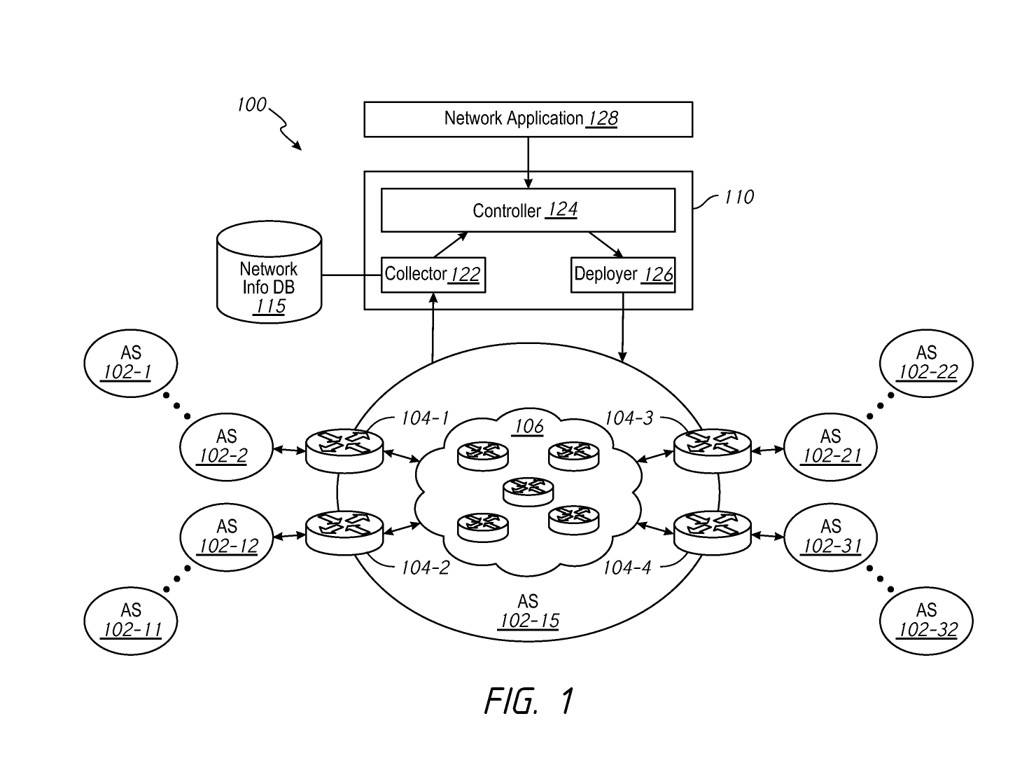

FIG. 1 is a block diagram of an example data network environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the data network environment 100 includes a plurality of autonomous systems 102, a network controller 110, a network information database 115, and a network application 128. In accordance with some implementations, an autonomous system (AS) refers to a group of routers within a network that are subject to common administration and a same interior gateway protocol (IGP) such as the open shorted path first (OSPF) protocol, the intermediate system to intermediate system (IS-IS) protocol, or the like. In some implementations, those of ordinary skill in the art will appreciate from the present disclosure that the data network environment 100 includes an arbitrary number of AS's.

As shown in FIG. 1, an AS 102-15 (sometimes also herein referred to as the “customer network” or the “monitored network”) includes a plurality of border routers 104-1, 104-2, 104-3, and 104-4 configured to connect the AS 102-15 with other AS's. For example, the border routers 104 communicate with AS's that are external to the AS 102-15 via an exterior gateway protocol (EGP) such as the border gateway protocol (BGP). The border routers 104 are also connected to a plurality of intra-AS routers 106 within the AS 102-15 (e.g., core routers). Intra-AS routers 106 broadly represent any element of network infrastructure that is configured to switch or forward data packets according to a routing or switching protocol. In some implementations, the intra-AS routers 106 comprise a router, switch, bridge, hub, gateway, etc. In some implementations, the intra-AS routers 106 form the core of the AS 102-15 and use a same routing protocol such as segment routing in an IPv6 data plane. In some implementations, those of ordinary skill in the art will appreciate from the present disclosure that the AS 102-15 includes an arbitrary number of border routers 104 and an arbitrary number of intra-AS routers 106.

In some implementations, the network controller 110 provides source/segment routing via centralized control of the AS 102-15. As such, in some implementations, the core network (e.g., the intra-AS routers 106 in FIG. 1) need not use MPLS with RSVP-TE signaling, which is not scalable in core networks because it requires routers to maintain link state information for N² routers in the network. According to some implementations, the core network runs IPv6.

In some implementations, the network controller 110 includes a collector 122 configured to collect network information from the nodes of the AS 102-15. In some implementations, the network controller 110 also includes a controller 124 configured to route traffic traversing the AS 102-15 or within the AS 102-15. According to some implementations, the controller 124 is also configured to simulate and improve the functioning of the AS 102-15. In some implementations, the network controller 110 further includes a deployer 126 configured to deploy changes and/or updates to the nodes of the AS 102-15. According to some implementations, a network application 128 controls or sets parameter(s) for the network controller 110.

In some implementations, at least some of the nodes within the AS 102-15, such as the border routers 104 or at least some of the intra-AS routers 106, are configured to monitor the traffic traversing its associated interfaces according to a predefined sampling frequency (e.g., 30 seconds, 60 seconds, 90 seconds, 5 minutes, 15 minutes, or the like). According to some implementations, each node processes each packet (e.g., Internet protocol (IP) packets) that traverses it to determine the number of bits associated with the packets to maintain traffic counters for each associated interface. In various implementations, routers and/or switches are enabled to maintain traffic counters, for example, by monitoring and tracking various fields within packets such as the number of bits associated with each packet.

In some implementations, at least some of the nodes within the AS 102-15, such as the border routers 104 or at least some of the intra-AS routers 106, are configured to periodically provide network information to the network controller 110. According to some implementations, the network information includes topology information, traffic information, state/configuration information, and power consumption information. In some implementations, the nodes export the network information to the network controller 110 according to a predefined monitoring period (e.g., every 30 seconds, 60 seconds, 90 seconds, 5 minutes, 15 minutes, etc.). In some implementations, the network controller 110 sends requests to the nodes for network information according to the predefined monitoring period.

In some implementations, the network information database 115 stores the network information provided by the nodes within the AS 102-15. In other words, the network information database 115 stores internal information corresponding to the AS 102-15 (e.g., acquired via the simple network management protocol (SNMP), the network configuration (NETCONF) protocol, the command-line interface (CLI) protocol, or another protocol) such as interface names, IP addresses used by the interfaces, router names, topology information, interface status information (e.g., enabled or disabled), traffic and utilization information, and power consumption information.

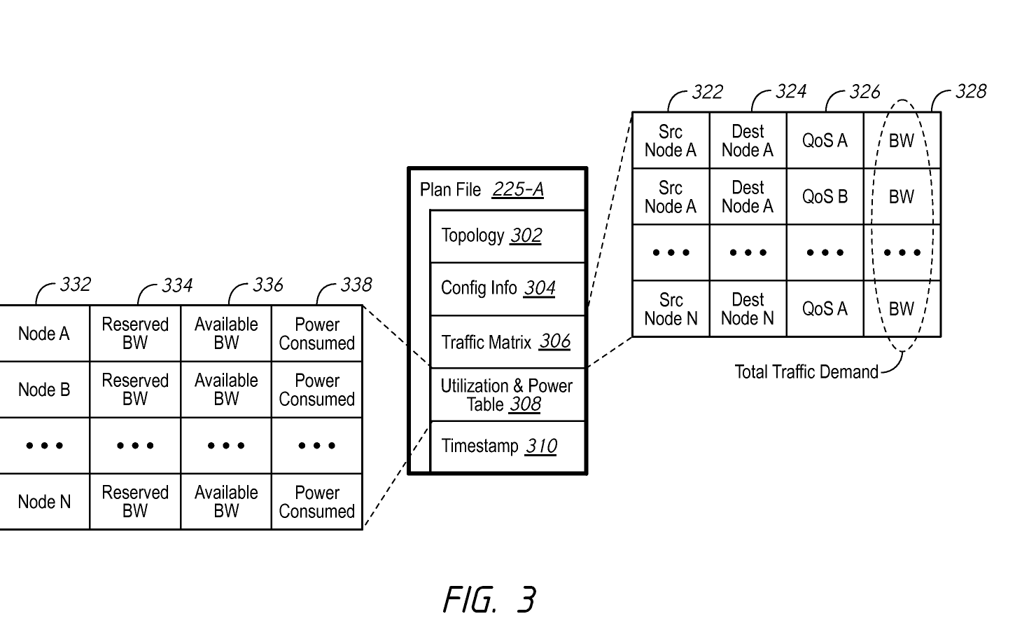

In some implementations, for each monitoring period, the network controller 110 produces a plan file that is stored in the network information database 115 based on network information collected from the nodes within the AS 102-15 for the respective monitoring period. According to some implementations, each plan file at least includes a traffic matrix described in more detail with reference to FIG. 3. According to some implementations, the traffic matrix characterizes the end-to-end traffic handled by the network for the monitoring period. According to some implementations, the traffic matrix is decoupled from the physical network. In other words, the traffic matrix is topology-neutral. According to some implementations, each plan file also includes a utilization and power table described in more detail with reference to FIG. 3.

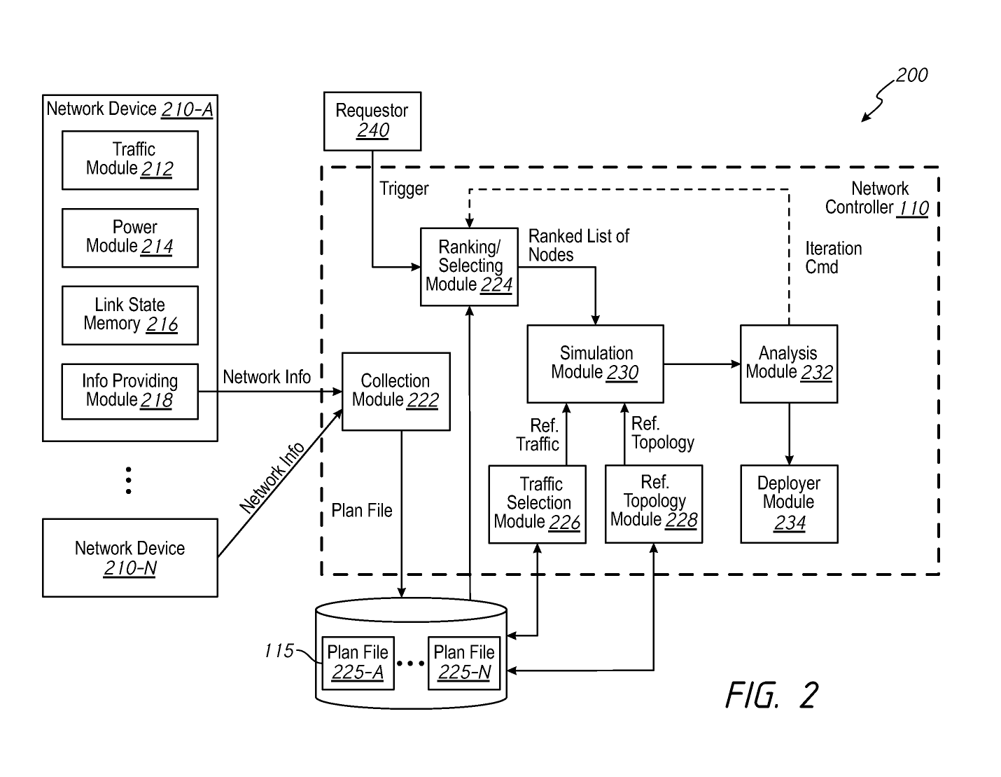

FIG. 2 is a block diagram of a data processing environment 200 in accordance with some implementations. The data processing environment 200 shown in FIG. 2 is similar to and adapted from the data network environment 100 shown in FIG. 1. Elements common to FIGS. 1 and 2 include common reference numbers, and only the differences between FIGS. 1 and 2 are described herein for the sake of brevity. To that end, the data processing environment 200 includes the network controller 110, the network information database 115, and a plurality of network devices 210-A, . . . , 210-N.

For example, the network devices 210-A, . . . , 210-N correspond to at least some of the border routers 104 and at least some of the intra-AS routers 106 within the AS 102-15 in FIG. 1. In some implementations, representative network device 210-A includes a traffic module 212, a power module 214, a link state memory 216, and an information providing module 218.

In some implementations, the traffic module 212 is configured to monitor the traffic traversing the interfaces associated with the network device 210-A. For example, the traffic module 212 maintains a traffic counter for each of its associated interfaces for a predefined monitoring period. In some implementations, the power module 214 is configured to monitor the power consumed by the network device 210-A and its associated interfaces. In some implementations, the traffic module 212 maintains a power efficient metric for each of the interfaces associated with the network device 210-A, which is a function of the real-time bandwidth serviced by an interface and the power consumed by the interface. In some implementations, the link state memory 216 stores topology information (e.g., the topology of the network, such as the AS 102-15 in FIG. 1, as observed by the network device 210-A) and state/configuration information for the network device 210-A and, optionally, other network devices 210.

In some implementations, the traffic module 212 maintains a utilization metric for each of the interfaces associated with the network device 210-A, which is a function of the real-time bandwidth serviced by an interface and the available bandwidth of the interface. In some implementations, the traffic module 212 maintains a utilization metric for each of the interfaces associated with the network device 210-A, which is a function of the bandwidth reserved on an interface and the available bandwidth of the interface.

In some implementations, the information providing module 218 is configured to export network information to the network controller 110 according to a predefined monitoring period. In some implementations, the information providing module 218 is configured to import network information to the network controller 110 in response to a request from the network controller 110. According to some implementations, the network information includes topology information, traffic information (e.g., traffic counters for each interface associated with the network device 210-A), power consumption information, and state/configuration information (e.g., the status of each interface associated with the network device 210-A). For example, the network information is exported or imported using the SNMP, the stream control transmission protocol (SCTP), as a file, or the like. In some implementations, the information providing module 218 is configured to provide network information for a last monitoring period to the network controller 110 in response to a query from the network controller 110.

In some implementations, the network controller 110 includes a collection module 222, which is configured to collect network information from network devices 210 for a respective monitoring period. In some implementations, the collection module 222 is also configured to produce a plan file for the respective monitoring period from the collected network information and store the plan file in the network information database 115. In some implementations, the network information database 115 stores a plurality of plan files 225-A, . . . , 225-N, where each of the plan files corresponds to a respective monitoring period. The plan files 225 are described in more detail herein with reference to FIG. 3.

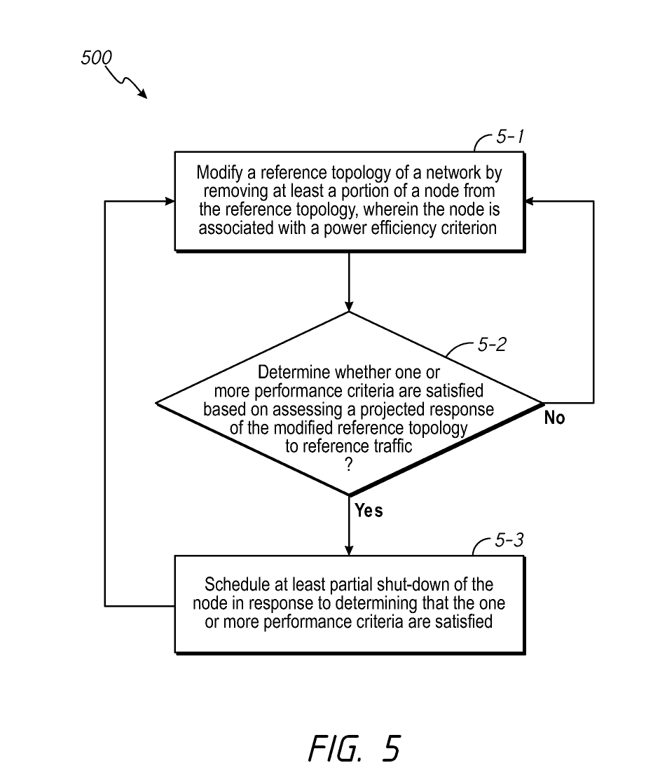

In some implementations, the network controller 110 also includes a request ranking/selection module 224, a traffic matrix selection module 226, a reference topology module 228, a simulation module 230, an analysis module 232, and a deployer module 234, the function and operation of which are described in greater detail below with reference to FIGS. 5, 6, and 7A-7C.

FIG. 3 is a block diagram of an example data structure for a representative plan file 225-A associated with a respective monitoring period in accordance with some implementations. According to some implementations, the plan file 225-A includes: a representation of information associated with the topology 302 of nodes in the network (e.g., the border routers 104 and the intra-AS routers 106 in the AS 102-15 in FIG. 1) during the respective monitoring period; configuration information 304 associated with the nodes in the network during the respective monitoring period; a traffic matrix 306 corresponding to the traffic traversing the network during the respective monitoring period; a utilization and power table 308 associated with the nodes in the network during the respective monitoring period; and a timestamp 310 indicative of the respective monitoring period.

As shown in FIG. 3, each row of the traffic matrix 306 is characterized by following fields: {source node 322, destination node 324, quality of service (QoS)/type of service 326, and bandwidth (BW) 328}. According to some implementations, the bandwidth field 328 characterizes the bandwidth consumed by the traffic flowing between the source and destination nodes. As such, the sum of the bandwidth column of the traffic matrix 306 characterizes the total traffic demand on the network or at least a sample thereof during the respective monitoring period.

As shown in FIG. 3, each row of the utilization and power table 308 is characterized by following fields: {node 332, reserved bandwidth (BW) 334, available bandwidth (BW) 336, and power consumed 338}. According to some implementations, the reserved bandwidth field 334 characterizes bandwidth reserved (e.g., in Gbps) for traffic scheduled to traverse the node during the respective monitoring period. In some implementations, the reserved bandwidth field 334 is replaced by the total bandwidth serviced by the node during the respective monitoring period. According to some implementations, the available bandwidth field 336 characterizes the total bandwidth that the node is capable of servicing during the respective monitoring period. According to some implementations, the power consumed field 338 characterizes the total power consumed by the node (e.g., in Watts (W)) during the respective monitoring period or its nominal power usage.

FIG. 5 is a flowchart representation of a method 500 of energy-aware routing in accordance with some implementations. In various implementations, the method 500 is performed by a network controller (e.g., the network controller 110 in FIGS. 1-2). While pertinent features are shown, those of ordinary skill in the art will appreciate from the present disclosure that various other features have not been illustrated for the sake of brevity and so as not to obscure more pertinent aspects of the example implementations disclosed herein. To that end, briefly, in some circumstances, the method 500 includes: modifying a reference topology by removing of a node from the reference topology; determining whether one or more performance criteria are satisfied based on assessing a projected response of the modified topology to reference traffic; and scheduling shut-down of the node in response to determining that the one or more performance criteria are satisfied.

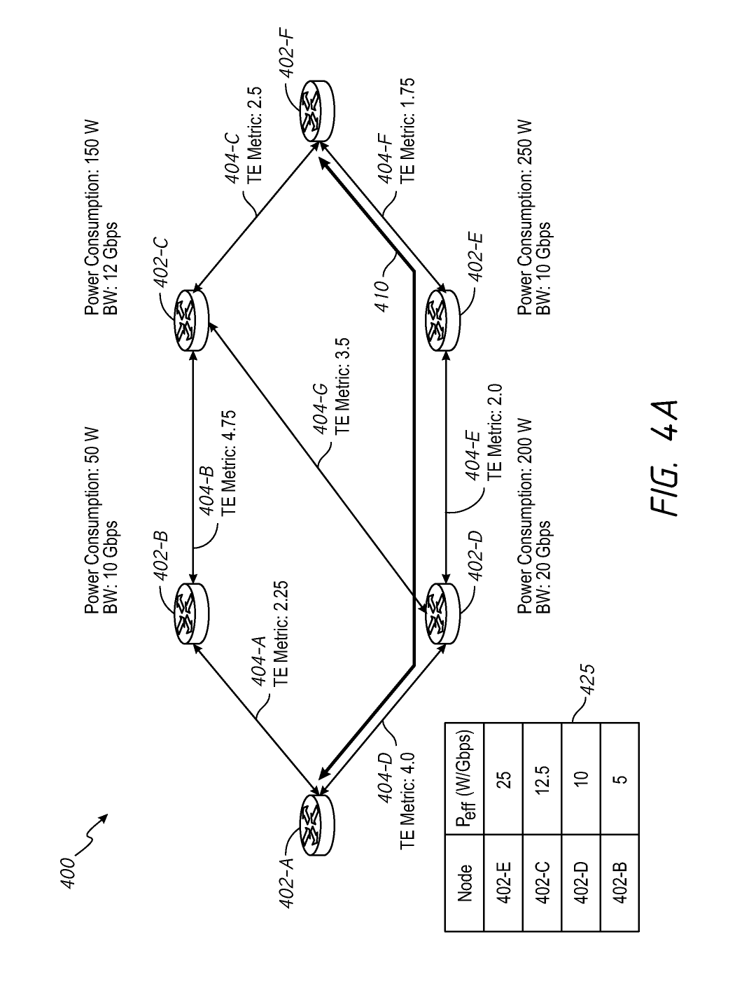

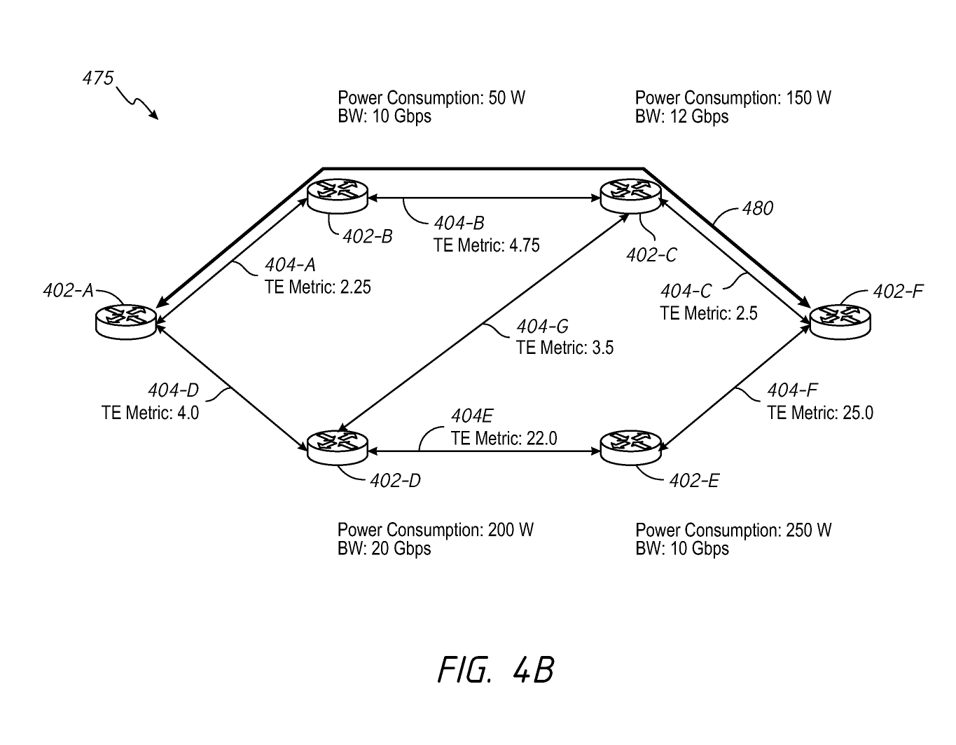

To that end, as represented by block 5-1, the method 500 includes modifying a reference topology by removing at least a portion of a node from the reference topology, where the mode is associated with a power efficiency criterion. In some implementations, the node is one of a router, a line card, an interface, or a bundle of one or more ports. For example, with reference to FIGS. 4A-4B, the network controller 110 or a component thereof (e.g., the simulation module 230 in FIG. 2) removes node 402-E from reference topology 400 in FIG. 4A to produce a modified reference topology. For example, the node 402-E is selected for removal because it satisfies the power efficiency criterion (e.g., power efficiency (P_{eff}) greater than or equal to 10 W/Gbps), and the node 402-E is the highest ranked node according to P_{eff} (W/Gbps) as shown in table 425 in FIG. 4A. One or ordinary skill in the art will appreciate that, in some implementations, the table 425 is alternatively organized according to energy efficiency (e.g., measured in Joules/bit of transit traffic).

In some implementations, based on the collected topology information, the network controller 110 or a component thereof (e.g., the reference topology module 228 in FIG. 2) maintains a reference topology of the network (e.g., the up-to-date as-built state of the network). For example, the reference topology 400 in FIG. 4A is the up-to-date as-built state of the network.

As represented by block 5-2, the method 500 includes determining whether one or more performance criteria are satisfied based on assessing a projected response of the modified topology to reference traffic. For example, with reference to FIGS. 4A-4B, the network controller 110 or a component thereof (e.g., the analysis module 232 in FIG. 2) determines whether one or more performance criteria (e.g., a latency threshold, a bandwidth utilization threshold, a redundancy criterion, a power consumption threshold, and/or the like) based on assessing or determining a projected response of the modified reference topology.

In some implementations, the network controller 110 or a component thereof (e.g., the traffic selection module 226 in FIG. 2) determines or selects reference traffic based at least in part on traffic information stores in the plurality of plan files 225 in the network information database 115. In some implementations, the reference traffic is a past traffic matrix that represents a future time slot. For example, the future time slot is next Tuesday from 2:00 AM-4:00 AM (e.g., the scheduled time for removing the node 402-E). As such, in one example, a past traffic matrix from 2:00 AM-4:00 AM last Tuesday is used as the reference traffic. In another example, a trend of the traffic from the last three Tuesdays from 2:00 AM-4:00 AM is used as the reference traffic.

In some implementations, the method 500 assesses the projected response of the modified reference topology to reference traffic comprises performing a simulation by applying the reference traffic to the modified reference topology. In some implementations, the user or operator of the network (e.g., the network application 128 in FIG. 1, or the requestor 240 in FIG. 2) receives the simulation results and/or approves the topology changes.

As represented by block 5-3, the method 500 includes scheduling at least partial shut-down of the node in response to determining that the one or more performance criteria are satisfied. For example, with reference to FIGS. 4A-4B, the network controller 110 or a component thereof (e.g., the deployer module 234 in FIG. 2) schedules at least partial shut-down of the node 404-E to conform the network to the modified reference topology. Furthermore, in some implementations, the network controller 110 or a component thereof (e.g., a tunnel configuration unit of the deployer module 234 in FIG. 2) also re-routes or merges one or more tunnels traversing the first node.

In some implementations, after performing block 5-3, the method 500 repeats block 5-1 by modifying the reference topology by removing at least a portion of a second node from the reference topology in addition to the previously selected node. According to some implementations, this iterative process continues until the simulation results fail to satisfy the one or more performance criteria. In other words, nodes are selected for shut-down until the performance criteria are not met. For example, with reference to FIGS. 4A-4B, the network controller 110 or a component thereof (e.g., the simulation module 230 in FIG. 2) removes node 402-C or a portion thereof (e.g., a linecard or port(s) associated with node 402-C) from reference topology 400 in addition to node 402-E (if possible) to produce a second modified reference topology (not shown). For example, the node 402-C is selected for removal because it satisfies the power efficiency criterion (e.g., P_{eff} greater than or equal to 10 W/Gbps) and is the second highest ranked node according to P_{eff} as shown in table 425 in FIG. 4A.

In some implementations, in response to determining that the one or more performance criteria are not satisfied, the method 500 foregoes block 5-3 and repeats block 5-1 by selecting a second node that satisfies the power efficiency criterion and modifying the reference topology by removing at least a portion of the second node from the reference topology. For example, with reference to FIGS. 4A-4B, the network controller 110 or a component thereof (e.g., the simulation module 230 in FIG. 2) removes node 402-C from reference topology 400 (if possible) to produce a second modified reference topology (not shown). For example, the node 402-C is selected for removal because it satisfies the power efficiency criterion (e.g., P_{eff} greater than or equal to 10 W/Gbps) and is the second highest ranked node according to P_{eff} as shown in table 425 in FIG. 4A.

In some implementations, in response to determining that the one or more performance criteria are not satisfied, the method 500 foregoes block 5-3 and re-routes or merges of one of more tunnels traversing the first node before repeating block 5-1.

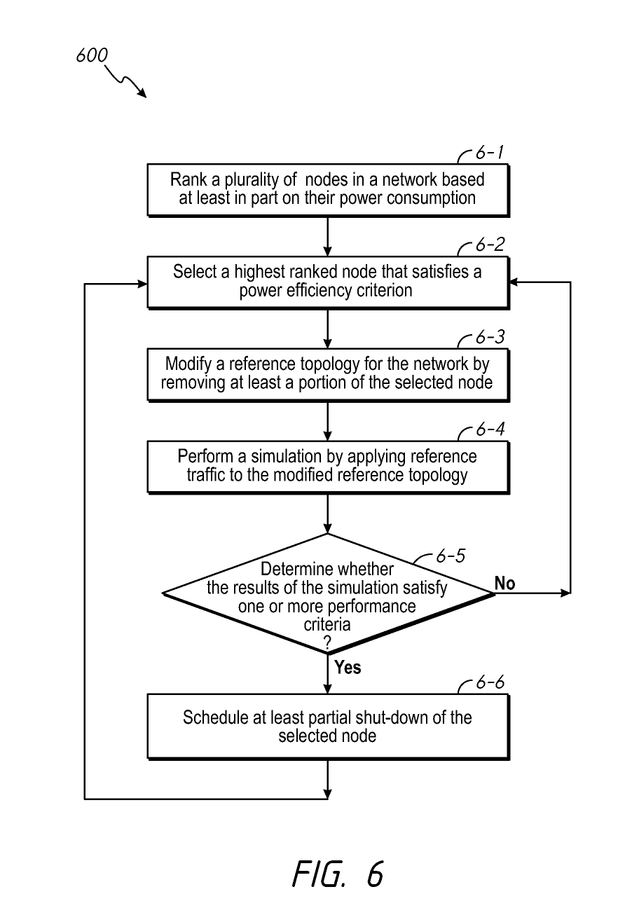

FIG. 6 is a flowchart representation of a method 600 of energy-aware routing in accordance with some implementations. In various implementations, the method 600 is performed by a network controller (e.g., the network controller 110 in FIGS. 1-2). While pertinent features are shown, those of ordinary skill in the art will appreciate from the present disclosure that various other features have not been illustrated for the sake of brevity and so as not to obscure more pertinent aspects of the example implementations disclosed herein. To that end, briefly, in some circumstances, the method 600 includes: ranking a plurality of nodes in a network based on their power consumption; selecting a highest ranked node that satisfies a power efficiency criterion; modifying a reference topology of the network by removing the selected node; performing a simulation by applying reference traffic to the modified reference topology; determining whether the results of the simulation satisfy one or more performance criteria; and scheduling shut-down of the selected node.

In some implementations, the method 600 includes obtaining a request (e.g., from the requestor 240 in FIG. 2) to attempt to reduce the power consumption of a network, which triggers block 6-1. In some implementations, the method 600 is triggered on-demand by a user/operator of the network (e.g., the network application 128 in FIG. 1, or the requestor 240 in FIG. 2) or is run according to a predefined schedule (e.g., hourly, daily, weekly, etc.). In some implementations, the method 600 is triggered when the total traffic serviced by the network is less than a threshold amount of traffic. In some implementations, the method 600 is triggered when the average traffic serviced by each node is less than a threshold amount of traffic.

As represented by block 6-1, the method 600 includes ranking a plurality of nodes in a network based at least in part on their power consumption. In some implementations, the nodes are one of a router, a line card, and interface, or a bundle of one or more ports. For example, with reference to FIG. 4A, the network controller 110 or a component thereof (e.g., ranking/selection module 224 in FIG. 2) ranks the nodes 402 in reference topology 400 from highest to lowest according to the power efficiency (P_{eff}) of each node as shown in table 425. For example, the node 402-E, which is the highest ranked in the table 425, consumes 250 W (e.g., an average of the instantaneous power consumed by the node 402-E during the respective monitoring period or the total power consumed during the respective monitoring period). Continuing with this example, the node 402-E processes or is capable of processing 10 Gbps. In one non-limiting example, the 10 Gbps has been reserved on node 402-E for the respective monitoring period. In another non-limiting example, the node 402-E services a total of 10 Gbps during the respective monitoring period. Thus, as shown in the table 425, the power efficiency (P_{eff}) of node 402-E is approximately 25 W/Gbps

$$( e . g . , \frac{250 W}{10 Gbps} ) .$$

For example, a collector/discovery module (e.g., the collection module 222 in FIG. 2) collects topology (e.g., using SNMP and BGP-LS to collect OSPF-TE and IS-IS-TE info), traffic (e.g., traffic counters indicating aggregate traffic per interface), and power consumption information (e.g., actual or nominal power measurements, otherwise MIBs) from nodes in the network. In some implementations, based on the collected traffic and power consumption info, the network controller 110 or a component thereof (e.g., ranking/selection module 224 in FIG. 2) maintains a list of nodes organized from highest to lowest according to their respective P_{eff} (e.g., the table 425 in FIG. 4A). One or ordinary skill in the art will appreciate that, in some implementations, the table 425 is alternatively organized according to energy efficiency (e.g., measured in Joules/bit of transit traffic).

As represented by block 6-2, the method 600 includes selecting a highest ranked node that satisfies a power efficiency criterion. For example, with reference to FIG. 4A, the network controller 110 or a component thereof (e.g., the ranking/selection module 224 in FIG. 2) selects the node 402-E because it satisfies the power efficiency criterion (e.g., P_{eff} greater than or equal to 10 W/Gbps) and is the highest ranked node according to P_{eff} as shown in table 425 in FIG. 4A.

In some implementations, the power efficiency criterion is satisfied when the P_{eff} of a node exceeds a predefined threshold (e.g., 10 W/Gbps). In some implementations, the power efficiency criterion is satisfied when the P_{eff} of a node exceeds a predefined threshold (e.g., 10 W/Gbps) and its power consumption exceeds a predefined consumption threshold (e.g., 50 W).

As represented by block 6-3, the method 600 includes modifying a reference topology of the network by removing at least a portion of the selected node. For example, with reference to FIGS. 4A-4B, the network controller 110 or a component thereof (e.g., the simulation module 230 in FIG. 2) removes node 402-E from reference topology 400 in FIG. 4A to produce a modified reference topology.

In some implementations, based on the collected topology information, the network controller 110 or a component thereof (e.g., the reference topology module 228 in FIG. 2) maintains a reference topology of the network (e.g., the up-to-date as-built state of the network). For example, the reference topology 400 in FIG. 4A is the up-to-date as-built state of the network.

As represented by block 6-4, the method 600 includes performing a simulation by applying reference traffic to the modified reference topology. For example, with reference to FIGS. 4A-4B, the network controller 110 or a component thereof (e.g., the simulation module 230 in FIG. 2) performs a simulation by applying reference traffic to the modified reference topology.

In some implementations, the network controller 110 or a component thereof (e.g., the traffic selection module 226 in FIG. 2) determines or selects reference traffic based at least in part on traffic information stored in the plurality of plan files 225 in the network information database 115. In some implementations, the reference traffic is a past traffic matrix that represents a future time slot. For example, the future time slot is next Tuesday from 2:00 AM-4:00 AM (e.g., the scheduled time for removing the node 402-E). As such, in one example, a past traffic matrix from 2:00 AM-4:00 AM last Tuesday is used as the reference traffic. In another example, a trend of the traffic from the last three Tuesdays from 2:00 AM-4:00 AM is used as the reference traffic.

As represented by block 6-5, the method 600 includes determining whether the results of the simulation satisfy one or more performance criteria. For example, with reference to FIGS. 4A-4B, the network controller 110 or a component thereof (e.g., the analysis module 232 in FIG. 2) determines whether the results of the simulation satisfy one or more performance criteria. In some implementations, the one or more performance criteria include at least one of a latency threshold, a bandwidth utilization threshold, a redundancy criterion, and a power consumption threshold. For example, with reference to the modified topology, as a result of the simulation, data must be routed from node 402-A to node 402-F in less than 100 ms in order to satisfy the latency threshold. In another example, with reference to the modified topology, as a result of the simulation, no nodes can exceed 80% utilization in order to satisfy the bandwidth utilization threshold. In another example, as a result of the removal of the node 402-E, there must be at least three distinct paths from node 402-A to note 402-F in order to satisfy the redundancy requirement criterion. In yet another example, as a result of the simulation, the total power consumption for the network is less than a predetermined threshold (e.g., 500 W, 1 kW, etc.) in order to satisfy the power consumption threshold.

As represented by block 6-6, the method 600 includes scheduling at least partial shut-down of the selected node. For example, with reference to FIGS. 4A-4B, the network controller 110 or a component thereof (e.g., the deployer module 234 in FIG. 2) schedules at least partial shut-down of the node 404-E to conform the network to the modified reference topology. In some implementations, a power manager unit of the deployer module 234 module turns on/off nodes and/or components thereof or puts them in sleep mode.

In some implementations, the method 600 schedules at least partial shut-down of the node by increasing a metric of at least one of: the node and the links connected to the node. In some implementations, the network controller 110 or a component thereof (e.g., a tunnel configuration unit (not shown) of the deployer module 234 in FIG. 2) gracefully handles the shut-down of the node by increasing its traffic engineering (TE) metrics (e.g., “poisoning” the node) to avoid packet loss or setting its associated IS-IS overload bit (or its equivalent in OSPF). For example, with reference to FIG. 4A-4B, the deployer module 234 in FIG. 2 schedules at least partial shut-down of the node 402-E in FIG. 4B by increasing TE metrics of links 404-E and 404-F adjacent to the node 402-E.

Furthermore, in some implementations, the network controller 110 or a component thereof (e.g., the tunnel configuration unit of the deployer module 234 in FIG. 2) re-routes or merges tunnels or label switched paths (LSPs) in preparation for traffic diversion from the node. For example, the network controller 110 re-routes tunnel 410 in FIG. 4A (e.g., following nodes 402-A, 402-D, 402-E, 402-F) to tunnel 480 in FIG. 4B (e.g., following nodes 402-A, 402-B, 402-C, 402-F).

In some implementations, after performing block 6-6, the method 600 repeats block 6-2 by selecting a second highest ranked node or a portion thereof (e.g., a linecard or port(s)) that satisfies the power efficiency criterion and modifying the reference topology by removing at least a portion of the second node from the reference topology in addition to the previously selected node. According to some implementations, this iterative process continues until the simulation results fail to satisfy the one or more performance criteria. In other words, nodes are selected for shut-down until the performance criteria are not met. For example, with reference to FIGS. 4A-4B, the network controller 110 or a component thereof (e.g., the simulation module 230 in FIG. 2) removes node 402-C or a portion thereof from reference topology 400 in addition to node 402-E (if possible) to produce a second modified reference topology (not shown). For example, the node 402-C is selected for removal because it satisfies the power efficiency criterion (e.g., P_{eff} greater than or equal to 10 W/Gbps) and is the second highest ranked node according to P_{eff} as shown in table 425 in FIG. 4A.

In some implementations, in response to determining that the one or more performance criteria are not satisfied, the method 600 foregoes block 6-6 and repeats block 6-2 by selecting a second highest ranked node or a portion thereof (e.g., a linecard or port(s)) that satisfies the power efficiency criterion and modifying the reference topology by removing at least a portion of the second node from the reference topology. For example, with reference to FIGS. 4A-4B, the network controller 110 or a component thereof (e.g., the simulation module 230 in FIG. 2) removes node 402-C or a portion thereof from reference topology 400 (if possible) to produce a second modified reference topology (not shown). For example, the node 402-C is selected for removal because it satisfies the power efficiency criterion (e.g., P_{eff} greater than or equal to 10 W/Gbps) and is the second highest ranked node according to P_{eff} as shown in table 425 in FIG. 4A.

In some implementations, in response to determining that the one or more performance criteria are not satisfied, the method 600 foregoes block 6-6 and re-routes or merges of one of more tunnels traversing the node before repeating block 6-2.

In some implementations, the network controller 110 monitors the traffic handled by the network and reactivates at least the portion of the first node in response to determining that the traffic handled by the network exceeds a threshold traffic level. According to some implementations, the node is powered-down when traffic patterns indicate a lull in traffic and brought back on-line when the traffic increases over the threshold traffic level. For example, the node is powered-down during typically low traffic period (e.g., 2:00 AM) and brought back on-line at a predefined time (e.g., 6:00 AM). In another example, the network controller 110 or a component thereof (e.g., the simulation module 230 in FIG. 2) continues to perform simulations after deployment by applying real-time traffic to the modified topology, the deployer module 234 reactivates at least the portion of the first node when these simulation results indicate that the one or more performance criteria are no longer satisfied.

In some implementations, the network controller 110 reactivates at least the portion of the node according to a predefined schedule (e.g., reactivation at a predefined time or after a predefined period of time). In some implementations, the network controller 110 reactivates at least the portion of the node according to a predictive schedule (e.g., reactivation when the network is expected to handle increased or peak traffic).

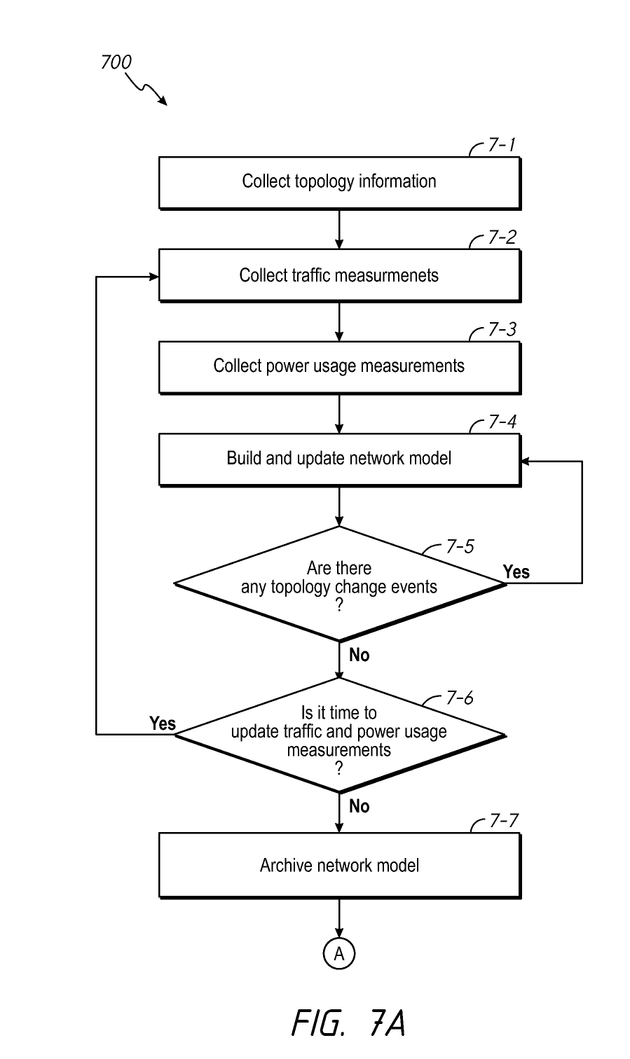

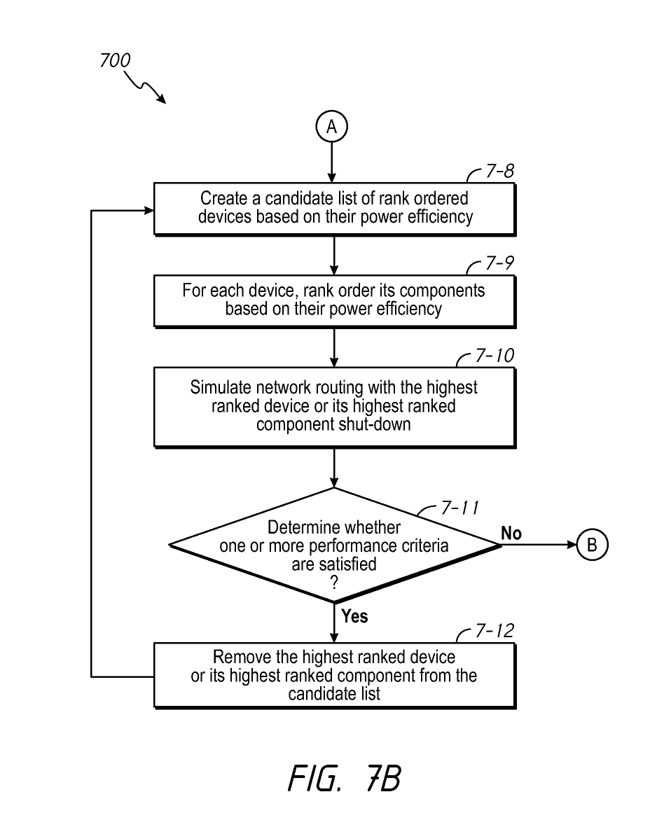

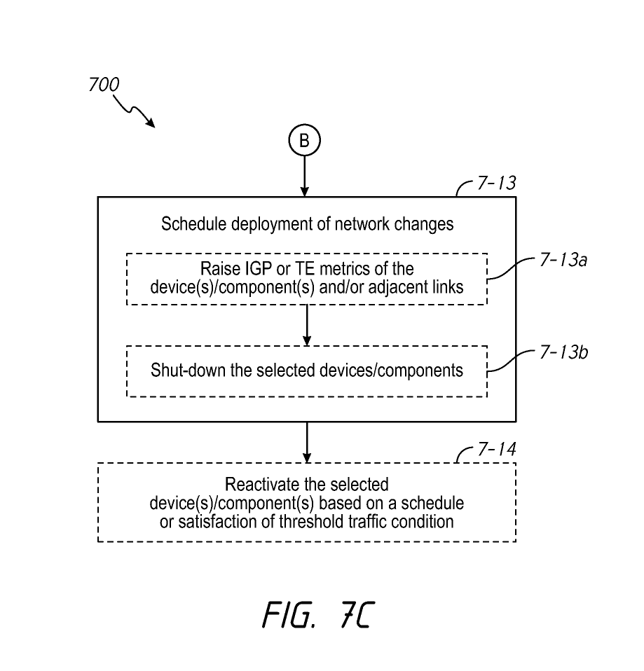

FIGS. 7A-7C show a flowchart representation of a method 700 of energy-aware routing in accordance with some implementations. In various implementations, the method 700 is performed by a network controller (e.g., the network controller 110 in FIGS. 1-2). While pertinent features are shown, those of ordinary skill in the art will appreciate from the present disclosure that various other features have not been illustrated for the sake of brevity and so as not to obscure more pertinent aspects of the example implementations disclosed herein.

To that end, as represented by block 7-1, the method 700 includes collecting topology information. For example, the network controller 110 or a component thereof (e.g., the collection module 222 in FIG. 2) collects topology information from the nodes (e.g., at least some of the border routers 104 and the intra-AS routers 106 in FIG. 1) in the network (e.g., the AS 102-15 in FIG. 1) for a respective monitoring period. For example, with reference to FIG. 2, link state memory 216 of the network device 210-A (e.g., one of the nodes in the AS 102-15 in FIG. 1) stores topology information (e.g., the topology of the network as observed by the network device 210-A).

As represented by block 7-2, the method 700 includes collecting traffic measurements. For example, the network controller 110 or a component thereof (e.g., the collection module 222 in FIG. 2) collects traffic measurements (e.g., traffic counters for each node and/or interface thereof) from the nodes (e.g., at least some of the border routers 104 and the intra-AS routers 106 in FIG. 1) in the network (e.g., the AS 102-15 in FIG. 1) for the respective monitoring period. For example, with reference to FIG. 2, the traffic module 212 of the network device 210-A (e.g., one of the nodes in the AS 102-15 in FIG. 1) maintains a traffic counter for each of its associated interfaces for the predefined monitoring period.

As represented by block 7-3, the method 700 includes collecting power usage measurements. For example, the network controller 110 or a component thereof (e.g., the collection module 222 in FIG. 2) collects power usage measurements (e.g., (e.g., actual or nominal power measurements, otherwise MIBs) from the nodes (e.g., at least some of the border routers 104 and the intra-AS routers 106 in FIG. 1) in the network (e.g., the AS 102-15 in FIG. 1) for the respective monitoring period. For example, with reference to FIG. 2, the power module 214 of the network device 210-A (e.g., one of the nodes in the AS 102-15 in FIG. 1) monitors the power consumed by the network device 210-A and its associated interfaces for the predefined monitoring period.

In some implementations, with reference to FIG. 2, the information providing module 218 of the network device 210-A is configured to export network information (including the topology information, the traffic measurements, and the power usage measurements) to the network controller 110 according to the predefined monitoring period (e.g., every 30 seconds, 60 seconds, 90 seconds, 5 minutes, 15 minutes, etc.). In some implementations, with reference to FIG. 2, the information providing module 218 is configured to provide network information (including the topology information, the traffic measurements, and the power usage measurements) for the last monitoring period to the network controller 110 in response to a query from the network controller 110.

As represented by block 7-4, the method 700 includes building and updating a network model based at least in part on the collected network information (including the topology information, the traffic measurements, and the power usage measurements). For example, the network controller 110 or a component thereof (e.g., the collection module 222 in FIG. 2) builds a new network model (e.g., of the AS 102-15 in FIG. 1) or updates an existing network model based at least in part on the network information (including the topology information, the traffic measurements, and the power usage measurements) collected for the respective monitoring period.

As represented by block 7-5, the method 700 includes determining whether any topology change events have occurred. The method 700 continues to block 7-6 in response to determining that no topology change events have occurred. The method 700 repeats block 7-4 in response to determining that at least one topology change event has occurred.

As represented by block 7-6, the method 700 includes determining whether a predefined time period has elapsed for updating the traffic measurements and the power usage measurements. The method 700 continues to block 7-7 in response to determining that the predefined time period has not elapsed. The method 700 repeats block 7-2 in response to determining in response to determining that the predefined time period has elapsed.

As represented by block 7-7, the method 700 includes archiving the network model. For example, the network controller 110 or a component thereof (e.g., the collection module 222 in FIG. 2) archives the network model by producing a plan file 225 (as shown in FIGS. 2-3) for the respective monitoring period based at least in part on the network information and storing the plan file 225 in the network information database 115.

As represented by block 7-8, the method 700 includes creating a candidate list of rank ordered devices based on their power efficiency. For example, the network controller 110 or a component thereof (e.g., the ranking/selection module 224 in FIG. 2) ranks the devices (e.g., routers, switches, or the like) in the network according to their power efficiency (P_{eff}). Alternatively, in some embodiments, the devices are ranked according to their energy efficiency.

As represented by block 7-9, the method 700 includes, for each device in the candidate list of rank ordered devices, rank ordering its components based on their power efficiency. For example, the network controller 110 or a component thereof (e.g., the ranking/selection module 224 in FIG. 2) ranks the components (e.g., line cards, ports, interfaces, or the like) devices in the network according to their P_{eff}.

As represented by block 7-10, the method 700 includes simulating network routing with the highest ranked device or its highest ranked component shut-down. For example, the network controller 110 or a component thereof (e.g., the simulation module 230 in FIG. 2) removes highest ranked device or its highest ranked component from a reference topology of the network. Continuing with this example, the network controller 110 or a component thereof (e.g., the simulation module 230 in FIG. 2) performs a network routing simulation by applying reference traffic to the modified reference topology.

In some implementations, the network controller 110 or a component thereof (e.g., the reference topology module 228 in FIG. 2) maintains a reference topology of the network (e.g., the up-to-date as-built state of the network). For example, the reference topology 400 in FIG. 4A is the up-to-date as-built state of the network. In some implementations, the network controller 110 or a component thereof (e.g., the traffic selection module 226 in FIG. 2) determines or selects reference traffic based at least in part on traffic information stored in the plurality of plan files 225 in the network information database 115.

As represented by block 7-11, the method 700 includes determining whether one or more performance criteria are satisfied based on the results of the simulation. For example, the network controller 110 or a component thereof (e.g., the analysis module 232 in FIG. 2) determines whether the results of the simulation satisfy one or more performance criteria (e.g., a latency threshold, a bandwidth utilization threshold, a redundancy criterion, a power consumption threshold, and/or the like).

The method 700 continues to block 7-12 in response to determining that the results of the simulation satisfy the one or more performance criteria. The method 700 continues to block 7-13 in response to determining that the results of the simulation do not satisfy the one or more performance criteria.

As represented by block 7-12, the method 700 includes removing the highest ranked device or its highest ranked component from the candidate list and subsequently repeats block 7-8. For example, with reference to FIG. 4A, the network controller 110 or a component thereof (e.g., the ranking/selection module 224 in FIG. 2) removes the highest ranked device or its highest ranked component from the candidate list.

As represented by block 7-13, the method 700 includes scheduling deployment of the network change(s). For example, the network controller 110 or a component thereof (e.g., the deployer module 234 in FIG. 2) schedules shut-down of the highest ranked device or its highest ranked component and/or any subsequently selected next-highest ranked devices or their highest ranked component.

In some implementations, as represented by block 7-13a, the method 700 includes raising the interior gateway protocol (IGP) or traffic engineering (TE) metrics of the device(s)/component(s) and/or adjacent links. For example, the network controller 110 or a component thereof (e.g., the deployer module 234 in FIG. 2) schedules shut-down of the highest ranked device or its highest ranked component by raising the IGP or TE metrics of the device or its highest ranked component and/or adjacent links. Alternatively, the network controller 110 or a component thereof (e.g., the deployer module 234 in FIG. 2) schedules shut-down of the highest ranked device or its highest ranked component by setting an associated IS-IS overload bit (or its equivalent in OSPF). Continuing with this example, in some circumstances, the network controller 110 or a component thereof (e.g., the deployer module 234 in FIG. 2) schedules shut-down of the subsequently selected next-highest ranked devices or their highest ranked component by raising the IGP or TE metrics of the next-highest ranked device or its highest ranked component and/or adjacent links.

In some implementations, as represented by block 7-13b, the method 700 includes shutting down the selected device(s)/component(s). For example, the network controller 110 or a component thereof (e.g., the deployer module 234 in FIG. 2) schedules shut-down of the highest ranked device or its highest ranked component by shutting down the highest ranked device or its highest ranked component. Continuing with this example, in some circumstances, the network controller 110 or a component thereof (e.g., the deployer module 234 in FIG. 2) schedules shut-down of the subsequently selected next-highest ranked devices or their highest ranked component by shutting down the subsequently selected next-highest ranked devices or their highest ranked component.

In some implementations, as represented by block 7-14, the method 700 includes reactivating the selected device(s)/component(s) based on a predefined schedule or satisfaction of threshold traffic. For example, in some implementations, the network controller 110 or a component thereof (e.g., the deployer module 234 in FIG. 2) reactivates the highest ranked device or its highest ranked component and/or any subsequently selected next-highest ranked devices or their highest ranked component according to a predefined schedule (e.g., reactivation at a predefined time or after a predefined period of time) or a predictive schedule (e.g., reactivation when the network is expected to handle increased or peak traffic).

In another example, in some implementations, the network controller 110 or a component thereof (e.g., the deployer module 234 in FIG. 2) reactivates the highest ranked device or its highest ranked component and/or any subsequently selected next-highest ranked devices or their highest ranked component in response to satisfaction of a threshold traffic condition. For example, the deployer module 234 reactivates the selected device(s)/component(s) when the total traffic handled by the reduced network breaches a predefined bandwidth threshold (e.g., 50 Gbps, 100 Gbps, etc.). In another example, the deployer module 234 reactivates the selected device(s)/component(s) when the average utilization of the nodes in the reduced network breaches a predefined threshold (e.g., 75%). In yet another example, the network controller 110 or a component thereof (e.g., the simulation module 230 in FIG. 2) continues to perform simulations after deployment by applying real-time traffic to the modified topology, the deployer module 234 reactivates the selected device(s)/component(s) when these simulation results indicate that the one or more performance criteria are no longer satisfied.

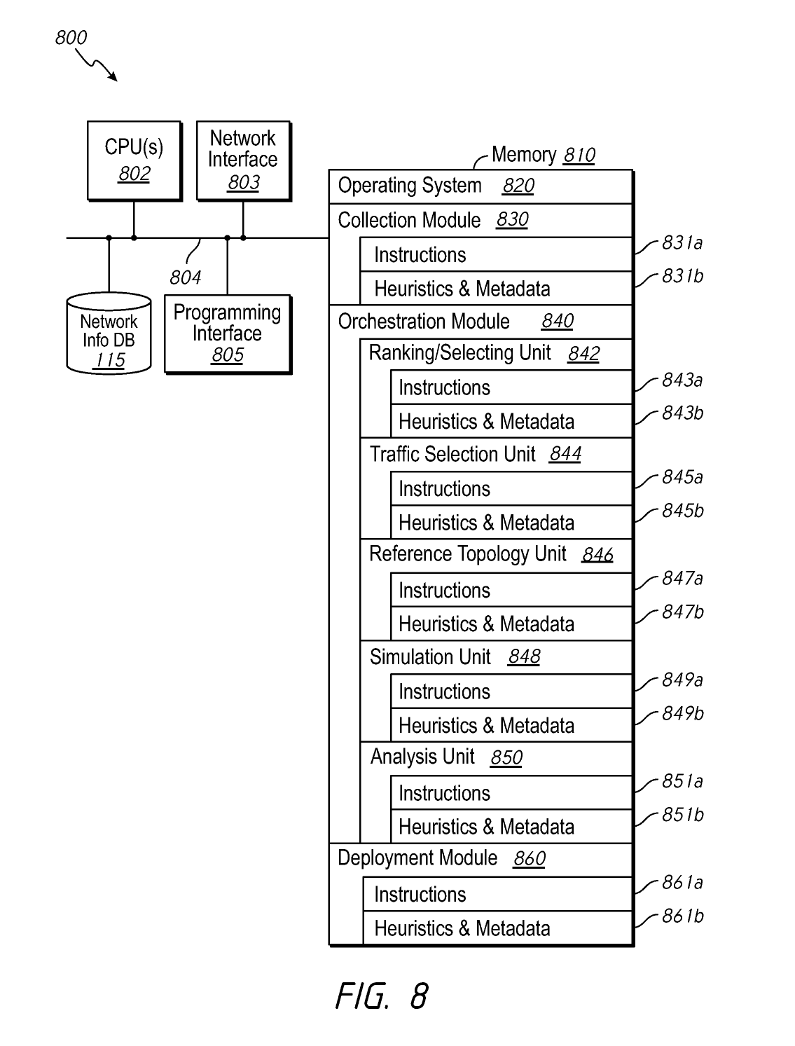

FIG. 8 is a block diagram of an example of a device 800 in accordance with some implementations. For example, in some implementations, the device 800 is similar to and adapted from the network controller 110 in FIGS. 1-2. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 800 includes one or more processing units (CPUs) 802, a network interface 803, a memory 810, a programming (I/O) interface 805, a network information database 115, and one or more communication buses 804 for interconnecting these and various other components.

In some implementations, the one or more communication buses 804 include circuitry that interconnects and controls communications between system components. The network information database 115 stores internal information related to a network (e.g., the AS 102-15 in FIG. 1) that is monitored by the device 800 and external information related to other external networks that are connected to said network. In some implementations, the network information database 115 stores a plurality of plan files 225-A, . . . , 225-N, where each of the plan files corresponds to a respective monitoring period.

The memory 810 includes high-speed random access memory, such as DRAM, SRAM, DDR RAM, or other random access solid state memory devices. In some implementations, the memory 810 includes non-volatile memory, such as one or more magnetic disk storage devices, optical disk storage devices, flash memory devices, or other non-volatile solid state storage devices. The memory 810 optionally includes one or more storage devices remotely located from the one or more CPUs 802. The memory 810 comprises a non-transitory computer readable storage medium. In some implementations, the memory 410 or the non-transitory computer readable storage medium of the memory 810 stores the following programs, modules and data structures, or a subset thereof including an optional operating system 820, a collection module 830, an orchestration module 840, and a deployment module 860.

The operating system 820 includes procedures for handling various basic system services and for performing hardware dependent tasks.

In some implementations, the collection module 830 is configured to collect network information from nodes in the network according to a monitoring period. In some implementations, the collection module 830 is also configured to produce a plan file for each monitoring period based at least in part on the collected network information and store the plan file in the network information database 115. To that end, in various implementations, the collection module 830 includes instructions and/or logic 831a, and heuristics and metadata 831b. According to some implementations, the collection module 830 is similar to and adapted from the collection module 222 in FIG. 2.

In some implementations, the orchestration module 840 is configured to route traffic traversing the network or within the network. In some implementations, the orchestration module 840 is also configured to control and optimize the functions of the network. To that end, in various implementations, the orchestration module 840 includes a ranking/section unit 842, a traffic selection unit 844, a reference topology unit 846, a simulation unit 848, and an analysis unit 850.

In some implementations, the ranking/section unit 842 is configured to maintain a list of nodes organized from highest to lowest according to their respective power efficiency (P_{eff}) (e.g., the table 425 in FIG. 4A). To that end, in various implementations, the ranking/section unit 842 includes instructions and/or logic 843a, and heuristics and metadata 843b. According to some implementations, the ranking/section unit 842 is similar to and adapted from the ranking/section module 224 in FIG. 2.

In some implementations, the traffic selection unit 844 is configured to determine or selects reference traffic based at least in part on traffic information stored in the plurality of plan files 225 in the network information database 115. To that end, in various implementations, the traffic selection unit 844 includes instructions and/or logic 845a, and heuristics and metadata 845b. According to some implementations, the traffic selection unit 844 is similar to and adapted from the traffic selection module 226 in FIG. 2.

In some implementations, the reference topology unit 846 is configured to maintain a reference topology of the network (e.g., the up-to-date as-built state of the network). To that end, in various implementations, the reference topology unit 846 includes instructions and/or logic 847a, and heuristics and metadata 847b. According to some implementations, the reference topology unit 846 is similar to and adapted from the reference topology module 228 in FIG. 2.

In some implementations, the simulation unit 848 is configured to produce a modified reference topology by removing a high ranked node that satisfies a power efficiency criterion from the reference topology maintained by the reference topology unit 846. In some implementations, the simulation unit 848 is also configured to perform a simulation by applying reference traffic selected by the traffic selection unit 844 to the modified reference topology. To that end, in various implementations, the simulation unit 848 includes instructions and/or logic 849a, and heuristics and metadata 849b. According to some implementations, the simulation unit 848 is similar to and adapted from the simulation module 230 in FIG. 2.

In some implementations, the analysis unit 850 is configured to determine whether the simulation results satisfy one or more performance criteria. To that end, in various implementations, the analysis unit 850 includes instructions and/or logic 851a, and heuristics and metadata 851b. According to some implementations, the analysis unit 850 is similar to and adapted from the analysis module 232 in FIG. 2.

In some implementations, the deployment module 860 is configured to schedule at least partial shut-down of the node in response to the analysis unit 850 determining that the one or more performance criteria are satisfied. To that end, in various implementations, the deployment module 860 includes instructions and/or logic 861a, and heuristics and metadata 861b. According to some implementations, the deployment module 860 is similar to and adapted from the deployer module 234 in FIG. 2.

Although the collection module 830, the orchestration module 840, and the deployment module 860 are illustrated as residing on a single device (i.e., the device 800), it should be understood that in other implementations, any combination of the collection module 830, the orchestration module 840, and the deployment module 860 reside in separate computing devices. For example, each of the collection module 830, the orchestration module 840, and the deployment module 860 reside on a separate device.

Moreover, FIG. 8 is intended more as functional description of the various features which be present in a particular embodiment as opposed to a structural schematic of the implementations described herein. As recognized by those of ordinary skill in the art, items shown separately could be combined and some items could be separated. For example, some functional modules shown separately in FIG. 4 could be implemented in a single module and the various functions of single functional blocks could be implemented by one or more functional blocks in various implementations. The actual number of modules and the division of particular functions and how features are allocated among them will vary from one embodiment to another and, in some implementations, depends in part on the particular combination of hardware, software, and/or firmware chosen for a particular embodiment.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular embodiments only and is not intended to be limiting of the claims. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
modifying a reference topology of a network by removing at least a portion of a first node from the reference topology, wherein the first node is associated with a power efficiency criterion;
determining whether one or more performance criteria are satisfied based on assessing a projected response of the modified reference topology to reference traffic; and
scheduling at least partial shut-down of the first node in response to determining that the one or more performance criteria are satisfied.

2. The method of claim 1, further comprising:
selecting the first node that satisfies the power efficiency criterion from among a plurality of nodes in the network.

3. The method of claim 2, wherein selecting the first node from the plurality of nodes in the network comprises selecting a highest ranked node from a ranked list of the plurality of nodes in the network that satisfies power efficiency criterion, wherein the nodes in the ranked list are sorted according to their power efficiency.

4. The method of claim 2, wherein the power efficiency criterion is satisfied when a ratio of power consumed to bandwidth serviced by the selected first node exceeds a power efficiency threshold.

5. The method of claim 1, wherein assessing the projected response of the modified reference topology to reference traffic comprises performing a simulation by applying the reference traffic to the modified reference topology.

6. The method of claim 1, wherein the first node is one of a router, a line card, or a bundle of one or more ports.

7. The method of claim 1, wherein the one or more performance criteria include at least one of a latency threshold, a bandwidth utilization threshold, a redundancy criterion, and a power consumption threshold.

8. The method of claim 1, wherein scheduling at least partial shut-down of the node comprises setting an overload indicator of the node.

9. The method of claim 1, wherein scheduling at least partial shut-down of the node comprises increasing metrics of at least one of: the node and the links connected to the node.

10. The method of claim 1, further comprising:
rerouting or merging of one of more tunnels traversing the first node in response to determining that the one or more performance criteria are satisfied.

11. The method of claim 1, further comprising:
foregoing scheduling at least partial shut-down of the first node in response to determining the one or more performance criteria are not satisfied.

12. The method of claim 11, further comprising:
rerouting or merging of one of more tunnels traversing the first node in response to determining the one or more performance criteria are not satisfied.

13. The method of claim 1, further comprising:
monitoring the traffic handled by the network; and
reactivating at least the portion of the first node in response to determining that the traffic handled by the network exceeds a threshold traffic level.

14. The method of claim 1, further comprising:
reactivating at least the portion of the first node according to a predefined or predictive schedule.

15. The method of claim 1, further comprising:
updating the modified reference topology of a network by removing at least a portion of a second node from the reference topology in addition to at least the portion of the first node in response to determining that the one or more performance criteria are satisfied, wherein the second node is associated with the power efficiency criterion;
determining whether the one or more performance criteria are satisfied based on assessing a projected response of the updated, modified reference topology to reference traffic; and
scheduling at least partial shut-down of the second node in response to determining that the one or more performance criteria are satisfied.

16. The method of claim 15, further comprising:
selecting the second node that satisfies the power efficiency criterion from among the plurality of nodes in the network in response to determining that the one or more performance criteria are satisfied.

17. The method of claim 15, wherein assessing the projected response of the updated, modified reference topology to reference traffic comprises performing a second simulation by applying the reference traffic to the updated, modified reference topology.

18. A non-transitory memory storing one or more programs, which, when executed by one or more processors of a device, cause the device to:
modify a reference topology of a network by removing at least a portion of a first node from the reference topology, wherein the first node is associated with a power efficiency criterion;
determine whether one or more performance criteria are satisfied based on assessing a projected response of the modified reference topology to reference traffic; and
schedule at least partial shut-down of the first node in response to determining that the one or more performance criteria are satisfied.

19. The non-transitory memory of claim 18, further comprising:
selecting the first node that satisfies the power efficiency criterion from among a plurality of nodes in the network.

20. A device comprising:
one or more processors;
a non-transitory memory;
means for modifying a reference topology of a network by removing at least a portion of a first node from the reference topology, wherein the first node is associated with a power efficiency criterion;
means for determining whether one or more performance criteria are satisfied based on assessing a projected response of the modified reference topology to reference traffic; and
means for scheduling at least partial shut-down of the first node in response to determining that the one or more performance criteria are satisfied.
